(19) United States
(12) Patent Application Publication
(10) Pub. No.: US 2005/0023969 A1
(43) Pub. Date: Feb. 3, 2005

(54) Organic EL display

(76) Inventors: Kazuyoshi Omata, Fukaya-Shi (JP); Reiko Yamashita, Fukaya-Shi (JP); Takeshi Iwasaki, Shimada-Shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/926,219

(22) Filed: Aug. 26, 2004

Related U.S. Application Data
(63) Continuation of application No. PCT/JP03/11375, filed on Sep. 5, 2003.

(30) Foreign Application Priority Data
Sep. 12, 2002 (JP) 2002-266902
Aug. 8, 2003 (JP) 2003-206845

(51) Int. Cl. H05B 33/00

(52) U.S. Cl. 313/504; 313/506; 313/503; 313/509

(57) ABSTRACT

Provided is an organic EL display including a substrate, an insulating underlayer disposed over the substrate, a first electrode partially covering the insulating underlayer, a partition insulting layer disposed on the insulating underlayer and partially covering the first electrode, an organic layer including an emitting layer and disposed on an uncovered portion of the first electrode that is not covered with the insulating separator layer, and a second electrode disposed on the organic layer, wherein a surface of the organic layer that faces the substrate includes a first area and a second area interposed between the first area and a side surface of the insulating separator layer, and a distance between the substrate and the second area is shorter than a distance between the substrate and the first area.

### CROSS-REFERENCE TO RELATED APPLICATIONS

This is a Continuation Application of PCT Application No. PCT/JP03/11375, filed Sep. 5, 2003, which was not published under PCT Article 21(2) in English.

This application is based upon and claims the benefit of priority from prior Japanese Patent Applications No. 2002-266902, filed Sep. 12, 2002; and No. 2003-206845, filed Aug. 8, 2003, the entire contents of both of which are incorporated herein by reference.

### BACKGROUND OF THE INVENTION

1. Field of the Invention

The present invention relates to a display, and more particularly, to an organic EL (Electro-Luminescence) display.

2. Description of the Related Art

An organic EL display is a self-emission display and hence has a wide viewing angle and high response speed. As no backlight is needed, this type of display can have a thinner profile and be made lighter in weight. For these reasons, organic EL displays are recently attracting attention as a type that may well replace liquid crystal displays.

In the manufacturing process of an organic EL display, a method of drying a coating film formed by use of a solution containing an organic material is sometimes used when a buffer layer or emitting layer is formed. For example, an insulating separator layer provided with through-holes in one-to-one correspondence with pixels is formed on a substrate. By using these through-holes as liquid reservoirs, the through-holes are filled with a solution containing an organic material by a solution coating method, such as an inkjet deposition method. After that, the solvent is removed from the liquid films in the through-holes by drying these liquid films. In this manner, buffer layers are formed. Emitting layers can also be formed by the same method.

In this method, to place a coating solution, i.e., ink, for forming an emitting layer or buffer layer only in a through-hole, an organic material is used as the insulating separator layer, and this insulating separator layer is made ink-repellent by using a plasma gas or the like before inkjet film formation. However, the sidewalls of each through-hole formed in the insulating separator layer are ink-repellent, so the ink placed in the through-hole reduces the area of contact with the sidewalls. Therefore, when the insulating separator layer is made of an organic insulating layer alone, ink sometimes does not spread over the entire bottom of a recess defined by the through-hole. Accordingly, when the insulating separator layer is made of an organic insulating layer alone, a short circuit readily occurs between the anode and cathode.

For this reason, an insulating layer having higher affinity for ink than the organic insulating layer is normally formed below the organic insulating layer. That is, the insulating separator layer has a two-layered structure including such an insulating layer and organic insulating layer.

Unfortunately, the film thickness uniformity of an emitting layer is affected by the wettabilities of the inorganic and organic insulating layers with respect to the solution, the surface tension and viscosity of the solution, and the drying characteristics of the solvent. When the two-layered structure is used as the insulating separator layer, therefore, a central portion of the emitting layer often becomes thinner than the periphery of the layer.

If the film thickness of the emitting layer is uneven, an electric current concentrates to a thin portion. This current concentration not only interferes with uniform light emission in a pixel, but also causes early deterioration of the thin portion of the emitting layer. This shortens the light emission life of the display.

### BRIEF SUMMARY OF THE INVENTION

It is an object of the present invention to provide an organic EL display having a high emitting layer film thickness uniformity.

According to a first aspect of the invention, there is provided an organic EL display comprising a substrate, an insulating underlayer disposed over the substrate, a first electrode partially covering the insulating underlayer, a partition insulating layer disposed on the insulating underlayer and partially covering the first electrode, an organic layer including an emitting layer and disposed on an uncovered portion of the first electrode that is not covered with the insulating separator layer, and a second electrode disposed on the organic layer, wherein a surface of the organic layer that faces the substrate comprises a first area and a second area interposed between the first area and a side surface of the insulating separator layer, and a distance between the substrate and the second area is shorter than a distance between the substrate and the first area.

According to a second aspect of the invention, there is provided an organic EL display comprising a substrate, an insulating underlayer disposed over the substrate, a first electrode partially covering the insulating underlayer, a partition insulting layer disposed on the insulating underlayer and partially covering the first electrode, an organic layer including an emitting layer and disposed on an uncovered portion of the first electrode that is not covered with the insulating separator layer, and a second electrode disposed on the organic layer, wherein the insulating separator layer comprises a first insulating layer covering a periphery of the first electrode and a portion of the substrate that is not covered with the first electrode, the first insulating layer being provided with a first through-hole at a position corresponding to a central portion of the first electrode, and a second insulating layer disposed on the first insulating layer and provided with a second through-hole at a position corresponding to the first electrode, and wherein a sidewall of the second through-hole surrounds a region sandwiched between the first and second electrodes and having a contour corresponding to a contour of the first electrode.

According to a third aspect of the invention, there is provided an organic EL display comprising a substrate, an insulating underlayer disposed over the substrate, a first electrode partially covering the insulating underlayer, a partition insulting layer disposed on the insulating underlayer and partially covering the first electrode, an organic layer including an emitting layer and disposed on an uncovered portion of the first electrode that is not covered with the insulating separator layer, and a second electrode disposed on the organic layer, wherein the uncovered portion comprises a high-level portion and a low-level portion, the low-level portion being interposed between the high-level portion and a covered portion of the first electrode that is covered with the insulating separator layer, and an upper surface of the low-level portion being lower in height than an upper surface of the high-level portion.

In the first aspect, the insulating separator layer may comprise a first insulating layer covering a periphery of the first electrode and a portion of the substrate that is not covered with the first electrode, the first insulating layer being provided with a first through-hole at a position corresponding to a central portion of the first electrode, and a second insulating layer disposed on the first insulating layer and provided with a second through-hole at a position corresponding to the first electrode. In this structure, a sidewall of the second through-hole may surround a region sandwiched between the first and second electrodes and having a contour corresponding to a contour of the first electrode. The insulating separator layer may further form a trench surrounding the region, an inner sidewall and a bottom of the trench being composed of a surface of the first insulating layer, and an outer sidewall of the trench being composed of a surface of the second insulating layer.

Likewise, in the second aspect, the stacked body of the first and second insulating layers may form a trench surrounding the region, an inner sidewall and a bottom of the trench being composed of a surface of the first insulating layer, and an outer sidewall of the trench being composed of a surface of the second insulating layer.

In the first aspect, the uncovered portion may comprise a high-level portion and a low-level portion, the low-level portion being interposed between the high-level portion and a covered portion of the first electrode that is covered with the insulating separator layer. In this structure, an upper surface of the low-level portion may be lower in height than an upper surface of the high-level portion.

In the first and third aspects, the first electrode and the insulating separator layer may form a recess and a trench between the high-level portion and insulating separator layer, a bottom of the recess being composed of a surface of the low-level portion, and a bottom of the trench being composed of a surface of the insulating underlayer.

In the first and third aspects, the first electrode may comprises an electrode body and a terminal, the terminal outwardly extending from a periphery of the electrode body and made of the same material as the electrode body. The insulating separator layer may be provided with through-hole at a position corresponding to the first electrode. A sidewall of the through-hole may surround the electrode body, thereby forming, between the first electrode and insulating separator layer, an open annular trench which opens at a position of the terminal. In this structure, the electrode body may comprise the high-level portion, and the terminal may comprise the low-level portion.

In the first aspect, the low-level portion may surround the high-level portion.

In the first and third aspects, the insulating underlayer may be provided with a recess at a position corresponding to the low-level portion.

In the first to third aspects, the first electrode may be an anode, the second electrode may be a cathode. In this structure, the organic layer may further includes a buffer layer between the anode and the emitting layer.

In the first aspect, the insulating separator layer may comprise an inorganic insulating layer disposed on a portion of the substrate that is not covered with the first electrode, the inorganic insulating layer partially covering the first electrode, and an organic insulating layer disposed on the inorganic insulating layer. Alternatively, the insulating separator layer may be an organic insulating layer.

In the second aspect, the first insulating layer may be an inorganic insulating layer, and the second insulating layer may be an organic insulating layer.

### BRIEF DESCRIPTION OF THE SEVERAL VIEWS OF THE DRAWING

FIG. 1 is a sectional view schematically showing an organic EL display according to the first embodiment of the present invention;

FIG. 2 is a sectional view schematically showing an array substrate of an organic EL display according to a comparative example;

FIG. 3 is a sectional view showing, in an enlarged scale, a portion of an array substrate of the organic EL display shown in FIG. 1;

FIG. 4 is a plan view schematically showing a portion of the structure shown in FIG. 3;

FIG. 5 is a plan view schematically showing an organic EL display according to the second embodiment;

FIG. 6 is a sectional view taken along a line VI-VI of the organic EL display shown in FIG. 5;

FIG. 7 is a plan view schematically showing an organic EL display according to another comparative example;

FIG. 8 is a sectional view taken along a line VIII-VIII of the organic EL display shown in FIG. 7;

FIG. 9 is plan view schematically showing an organic EL display according to the third embodiment of the present invention; and

FIG. 10 is a sectional view taken along a line X-X of the organic EL display shown in FIG. 9.

### DETAILED DESCRIPTION OF THE INVENTION

Embodiments of the present invention will be described in detail below with reference to the accompanying drawings. In these drawings, the same reference numerals denote constituent elements which achieve the same or similar functions, and a repetitive explanation thereof will be omitted.

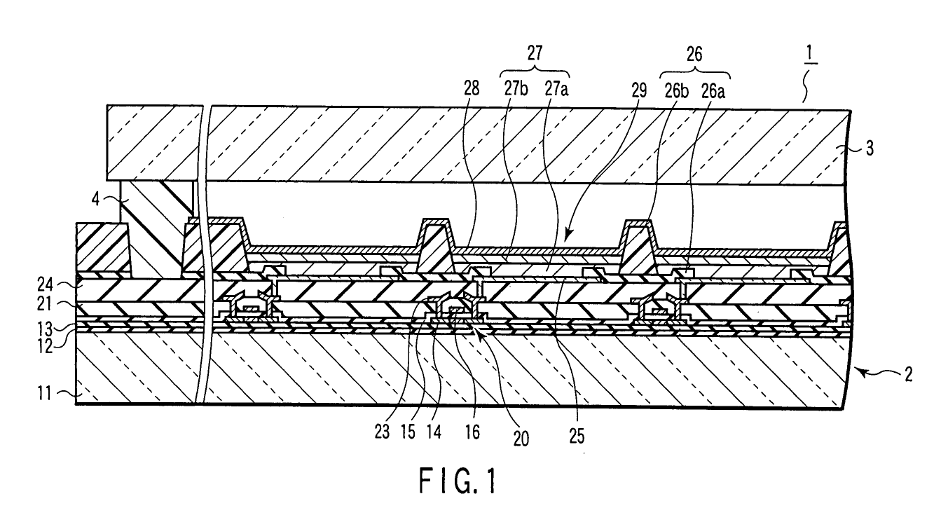

FIG. 1 is a sectional view schematically showing an organic EL display according to the first embodiment of the present invention. An organic EL display 1 shown in FIG. 1 has a structure in which an array substrate 2 and sealing substrate 3 face each other via a seal layer 4. The seal layer 4 extends along the periphery of the sealing substrate 3 to form a closed space between the array substrate 2 and sealing substrate 3. This space is filled with a rare gas such as Ar gas or an inert gas such as N₂ gas.

The array substrate 2 has a substrate 11. In this embodiment, the substrate 11 is a transparent insulating substrate having light transmittance, such as a glass substrate.

On the substrate 11, undercoating layers, e.g., an SiNₓ layer 12 and SiOₓ layer 13 are stacked in this order.

On the undercoating layer 13, a semiconductor layer 14 such as a polysilicon layer having a channel, source, and drain, a gate insulating film 15 which can be formed by, e.g., TEOS (TetraEthyl OrthoSilicate), and a gate electrode 16 made of, e.g., MoW, are stacked in this order, thereby forming a top gate type thin-film transistor (to be referred to as a TFT hereinafter) 20. On the gate insulating film 15, scanning signal lines (not shown) which can be formed in the same step as the gate electrode 16 are arranged.

The gate insulating film 15 and gate electrode 16 are covered with a dielectric interlayer 21 made of SiOₓ formed by, e.g. plasma CVD. Source/drain electrodes 23 are formed on the dielectric interlayer 21 and covered with a passivation film 24 made of, e.g., SiNₓ. The source/drain electrodes 23 have, e.g., a three-layered structure of Mo/Al/Mo, and are electrically connected to the source and drain of the TFT 20 through contact holes formed in the dielectric interlayer 21. On the dielectric interlayer 21, video signal lines (not shown) which can be formed in the same step as the source/drain electrodes 23 are arranged. In this embodiment, the passivation film 24 is an insulating underlayer.

On the passivation film 24, a plurality of first electrodes 25 are arranged spaced apart from one another. In this embodiment, the first electrode 25 is an anode formed as a transparent electrode having light transmittance, and made of a transparent conductive oxide such as ITO (Indium Tin Oxide). The first electrode 25 is electrically connected to the drain electrode 23 through a via-hole formed in the passivation film 24.

A first insulating layer 26a is also formed on the passivation film 24. The insulating layer 26a has first through-holes formed at positions corresponding to central portions of the first electrodes 25, and covers those portions of the passivation film 24, which are exposed from the first electrodes 25, and the periphery of the first electrodes 25. The insulating layer 26a is, e.g., an inorganic insulating layer which is hydrophilic or has high affinity for ink. The first electrodes 25 adjacent to each other are electrically insulated from each other by the insulating layer 26a.

A second insulating layer 26b is formed on the first insulating layer 26a. The second insulating layer 26b has second through-holes formed at positions corresponding to the first electrodes 25 and having a diameter larger than that of the first electrode 25. Each of these second through-holes surrounds a region sandwiched between the first electrode 25 and a second electrode 28 (to be described later) and having a contour corresponding to the contour of the first electrode 25. The insulating layer 26b is, e.g., an organic insulating layer which is ink-repellent or water-repellent. Note that the stacked body of the first insulating layer 26a and second insulating layer 26b forms an insulating separator layer 26 having through-holes formed at positions corresponding to the first electrodes 25.

On an uncovered portion of the first electrode 25, which is not covered with the insulating separator layer 26, an organic layer 27 including an emitting layer 27b is formed. In this embodiment, a buffer layer 27a and the emitting layer 27b form the organic layer 27. The buffer layer 27a mediates injection of holes from the first electrode 25 into the emitting layer 27b. The emitting layer 27b is, e.g., a thin film containing a luminescence organic compound which emits red, green, or blue light.

The second electrode 28 is formed on the insulating separator layer 26 and emitting layer 27b. The second electrode 28 is electrically connected to electrode lines through contact holes (not shown) formed in the passivation film 24 and insulating separator layer 26. Each organic EL element 29 is composed of the first electrode 25, organic layer 27, and second electrode 28.

The buffer layer 27a and emitting layer 27b of the organic EL display 1 can be formed by a solution coating method using a solution containing an organic solvent and organic compound. This solution uses a solvent having relatively high polarity. Accordingly, if the solvent content in the solution is sufficiently high, the wettability of the hydrophilic insulating layer 26a is high, and the wettability of the ink-repellent insulating layer 26b is low. Immediately after coating, therefore, a solution for forming the buffer layer 27a increases the area of contact with the insulating layer 26a, and decreases the area of contact with the insulating layer 26b. Likewise, immediately after coating, a solution for forming the emitting layer 27b decreases the area of contact with the insulating layer 26b.

Also, if the solvent content in the solution reduces, the polarity of the solution lowers. Consequently, a solution for forming the buffer layer 27a and a solution for forming the emitting layer 27b adhere to the sidewalls of the insulating layer 26b during the course of drying.

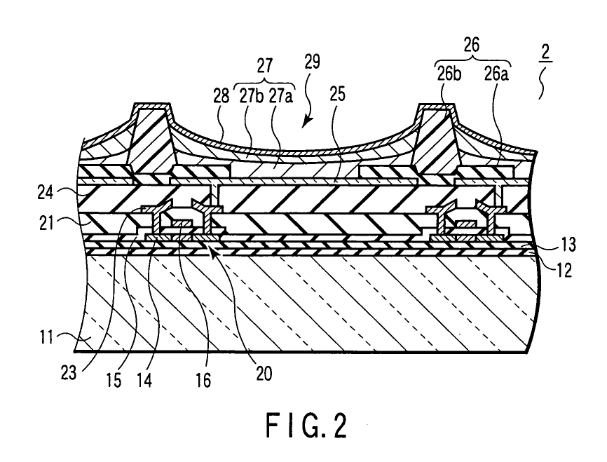

FIG. 2 is a sectional view schematically showing an array substrate of an organic EL display according to a comparative example.

In an array substrate 2 shown in FIG. 2, a second insulating layer 26b overlaps the periphery of first electrodes 25. Also, in the array substrate 2, those portions of a first insulating layer 26a, which are exposed from the second insulating layer 26b, are substantially flat. In this structure, a solution laterally spreads on the first insulating layer 26a, and reduces the area of contact with the second insulating layer 26b. Therefore, a buffer layer 27a rises near the surface of contact with the second insulating layer 26b, and this increases the film thickness near this contact surface. As a consequence, the film thicknesses of the buffer layer 27a and an emitting layer 27b largely decrease from the periphery toward the center not only on the insulating layer 26a but also in a position corresponding to a through-hole in the insulating layer 26a.

In an organic EL element 29, those portions of the buffer layer 27a and emitting layer 27b, which are positioned on the insulating layer 26a hardly contribute to light emission, and a portion corresponding to the through-hole in the insulating layer 26a mainly contributes to light emission. As shown in FIG. 2, therefore, if the film thickness nonuniformity of the buffer layer 27a and emitting layer 27b is large in a position corresponding to the through-hole in the insulating layer 26a, uneven light emission and early deterioration are readily caused by current concentration.

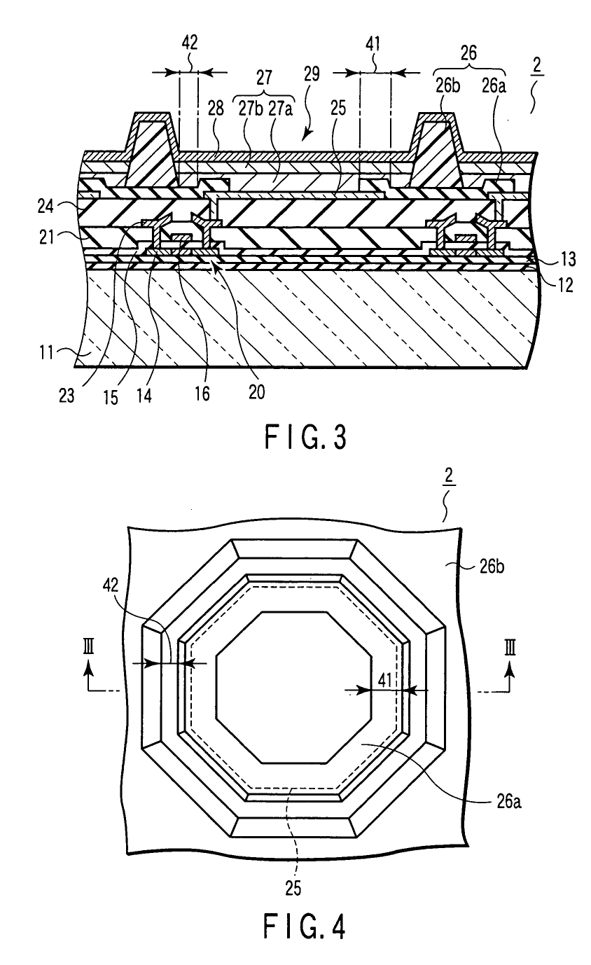

FIG. 3 is a sectional view showing, in an enlarged scale, a portion of the array substrate of the organic EL display 1 shown in FIG. 1. FIG. 4 is a plan view schematically showing a portion of the structure shown in FIG. 3. Note that in FIG. 4, the organic layer 27 and second electrode 28 are omitted. Note also that the section shown in FIG. 3 is equivalent to a section taken along a line III-III of the structure shown in FIG. 4.

In this embodiment, as shown in FIGS. 3 and 4, the insulating layer 26a having a through-hole formed in a position corresponding to the central portion of the first electrode 25 covers those portions of the passivation film 24 which are exposed from the first electrode 25, and the periphery of the first electrode 25. When this arrangement is used, an annular projection 41 corresponding to the periphery of the first electrode 25 and a lattice-like recess corresponding to the gaps between the first electrodes 25 are formed on the surface of the insulating layer 26a by an uneven surface structure formed by the passivation film 24 and first electrodes 25. Additionally, in this embodiment, the lattice-like recess formed in the surface of the insulating layer 26a is not completely filled with the insulating layer 26b, but the insulating layer 26b narrower than the recess is formed away from the sidewalls of the recess. In other words, the insulating layer 26b is formed in a position between the first electrodes 25 adjacent to each other, where the insulating layer 26b does not overlap the first electrodes 25. Consequently, as shown in FIGS. 3 and 4, a trench 42 surrounding the annular projection 41 formed on the surface of the insulating layer 26a is formed in the surface of the stacked body of the insulating layers 26a and 26b.

In this structure, the height of the surface of the underlayer, on which the buffer layer 27a is formed, increases from the lower end of the insulating layer 26b toward the center of the first electrode 25 and then decreases. Also, in this structure, the periphery of the buffer layer can be dropped in the trench 42 by the action of gravity. This prevents any rise of the periphery of the buffer layer 27a. In addition, when the buffer layer 27a and emitting layer 27b are formed, the force acting on the coating films can be optimized. As a consequence, a buffer layer 27a having high flatness and an emitting layer 27b having high film thickness uniformity are obtained. This makes it possible to suppress uneven light emission and early deterioration caused by current concentration.

When the structure shown in FIGS. 3 and 4 is used, a recess and projection corresponding to the projection 41 and trench 42 are formed on the surface of the organic layer 27 that faces the substrate 11. That is, in the structure shown in FIGS. 3 and 4, the surface of the organic layer 27 that faces the substrate 11 is composed of the first area corresponding to the upper surface of the projection 41, the second area corresponding to the bottom of the trench 42 and interposed between the first area and the side surfaces of the insulating separator layer 26, and the third area surrounded by the first and second areas. The distance between the substrate 11 and the second area is shorter than that between the substrate 11 and the first area. Also, the distance between the substrate 11 and the third area is shorter than that between the substrate 11 and the first area.

In this embodiment, the width of the trench 41 is preferably 1.0 μm or more. If the width of the trench 42 is too small, the above effect does not normally significantly appear. Also, the width of the trench 42 is preferably 4.0 μm or less. If the width of the trench 42 is large, the ratio of the area of the portion of the organic EL element 29 does not contribute to light emission increases.

In this embodiment, the depth of the trench 42 is preferably 50 nm or more. If the trench 42 is too shallow, the above effect does not normally significantly appear. The depth of the trench 42 has no upper limit. In this embodiment, however, the trench 42 is formed by using the thickness of the first electrode 25 as described above. Therefore, the depth of the trench 42 is normally 150 nm or less.

The second embodiment of the present invention will be described below. An organic EL display according to the second embodiment has substantially the same structure as the organic EL display according to the first embodiment except for the shape of the surface of the underlayer on which the an organic layer 27 is formed, and the structure of an insulating separator layer 26.

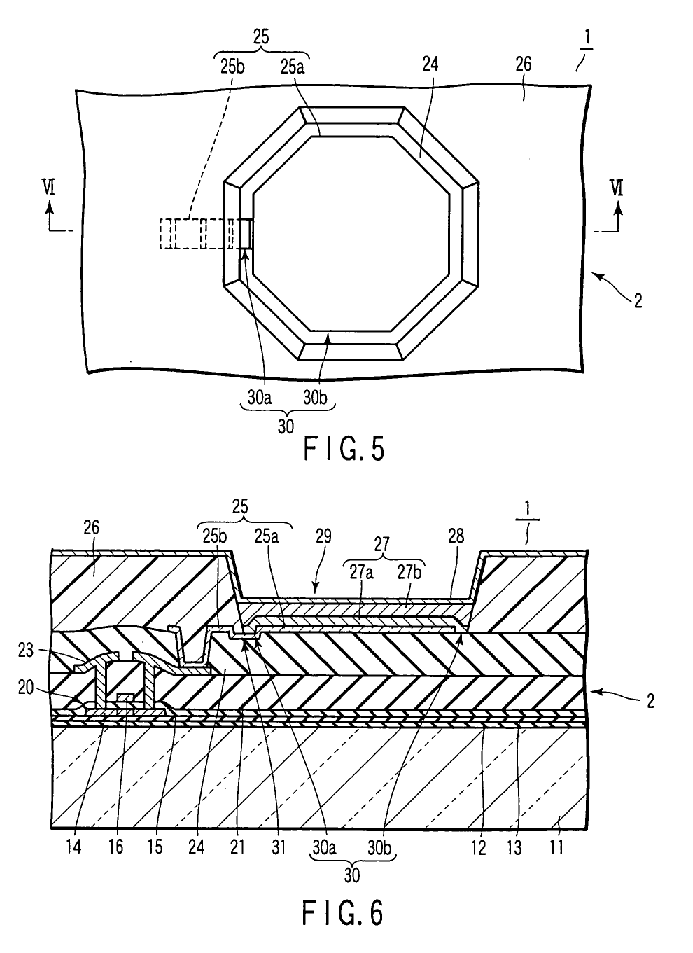

FIG. 5 is a plan view schematically showing the organic EL display according to the second embodiment of the present invention. FIG. 6 is a sectional view taken along a line VI-VI of the organic EL display shown in FIG. 5. Note that a second electrode 28 is omitted in FIG. 5.

An organic EL display 1 shown in FIGS. 5 and 6 has an array substrate 2. In the array substrate 2, a first electrode 25 is composed of an electrode body 25a, and a terminal 25b outwardly extending from a periphery of the electrode body 25a and made of the same material as the electrode body 25a. In this embodiment, the electrode body 25a has an octagonal shape, and is electrically connected to a drain electrode 23 via the terminal 25b. Also, in the array substrate 2, the insulating separator layer 26 has through-holes formed at positions corresponding to the electrode main bodies 25a. In this embodiment, each through-hole has an octagonal shape, and the sidewalls of the through-hole surround the electrode body 25a.

Similar to the organic EL display shown in FIG. 1, the organic EL display 1 shown in FIG. 5 normally further includes a sealing substrate 3 facing the second electrode 28, and a seal layer 4 formed along the periphery of the surface of the sealing substrate 3 that faces the second electrode 28, thereby forming a closed space between the second electrode 28 and sealing substrate 3. This space is filled with a rare gas such as Ar gas or an inert gas such as N₂ gas.

As in the first embodiment, a buffer layer 27a and emitting layer 27b of the organic EL display 1 can be formed by a solution coating method, e.g., an inkjet deposition method using ink containing an organic solvent and organic compound. When the solvent content is sufficiently large, this ink has low affinity for the surface of the insulating separator layer 26 which is made ink-repellent. Immediately after coating, therefore, the ink decreases the area of contact with the sidewalls of the insulating separator layer 26.

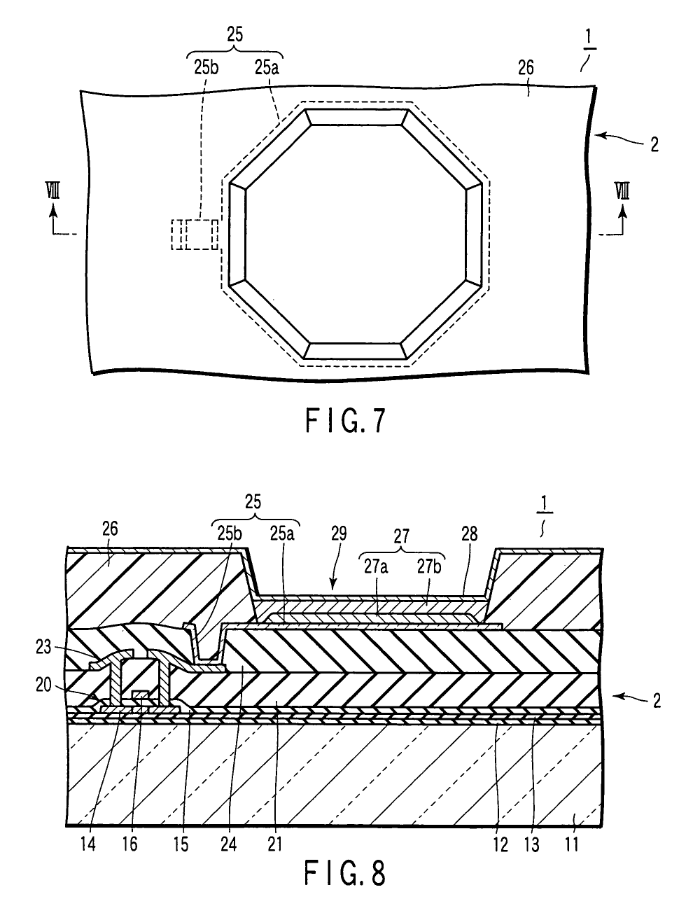

FIG. 7 is a plan view schematically showing an organic EL display according to another comparative example. FIG. 8 is a sectional view taken along a line VIII-VIII of the organic EL display shown in FIG. 7. Note that a second electrode 28 is omitted in FIG. 7.

When the bottom of a recess defined by a through-hole formed in an insulating separator layer 26 is flat as shown in FIGS. 7 and 8, defects of a buffer layer 27a and emitting layer 27b easily occur in peripheries thereof. For example, if defects occur in both peripheries of the buffer layer 27a and emitting layer 27b, a first electrode 25 and the second electrode 28 short-circuit. Also, if a defect occurs in a periphery of the buffer layer 27a, an electric current concentrates to the defective portion. This destroys an organic EL element 29 or shortens the life of the organic EL element 29.

By contrast, in this embodiment, as shown in FIGS. 5 and 6, the end portion of the terminal 25b that is connected to the electrode body 25a is positioned in the through-hole formed in the insulating separator layer 26, and a low-level portion having an upper surface lower than that of the electrode body (high-level portion) 25a is formed in this end portion of the terminal 25b. In this manner, a first recess 30a, whose bottom is the surface of the low-level portion, is formed between the electrode body 25a and insulating separator layer 26. Accordingly, the individual layers forming the organic layer 27 can be formed without defects, in the recess 30a by the action of a capillary phenomenon or the like. This makes it possible to suppress a short circuit between the first electrode 25 and second electrode 28 in the position of the terminal 25b.

In this embodiment, the through-hole in the insulating separator layer 26 is so formed that the sidewalls of the through-hole surround the electrode body 25a and are separated from the electrode body 25a by a predetermined spacing. In this manner, an open annular trench 30b which opens at the position of the terminal 25b is formed between the electrode body 25a and insulating separator layer 26. Furthermore, in this embodiment, a closed annular trench 30 is formed by the recess 30a and open annular trench 30b. That is, in this embodiment, the trench 30 surrounding the electrode body 25a is formed between the insulating separator layer 26 and electrode body 25a.

When the trench 30 is formed, ink can be spread over the entire bottom of the recess defined by the through-hole by the action of gravity or the like. Therefore, although a single-layer structure is used as the insulating separator layer 26, it is possible to suppress the formation of pin-holes on the peripheries of the buffer layer 27a and emitting layer 27b. This prevents easy occurrence of a short circuit between the first electrode 25 and second electrode 28.

Additionally, in this embodiment, even if defects of the layers that form the organic layer 27 occur at the periphery of the bottom of the through-hole formed in the insulating separator layer 26, since the electrode body 25a is not formed at the periphery, no short circuit easily occurs between the first electrode 25 and second electrode 28.

Note that when the structure shown in FIGS. 5 and 6 is used, a projection corresponding to the trench 30 is formed on the surface of the organic layer 27 that faces the substrate 11. That is, in the structure shown in FIGS. 5 and 6, the surface of the organic layer 27 facing the substrate 11 is composed of the first area corresponding to the upper surface of the electrode body 25a, and the second area corresponding to the bottom of the trench 30 and interposed between the first area and the insulating separator layer 26. The distance between the substrate 11 and the second area is shorter than that between the substrate 11 and the first area.

The third embodiment of the present invention will be described below. An organic EL display according to the third embodiment has substantially the same structure as the organic EL display according to the second embodiment except for the shape of a first electrode 25.

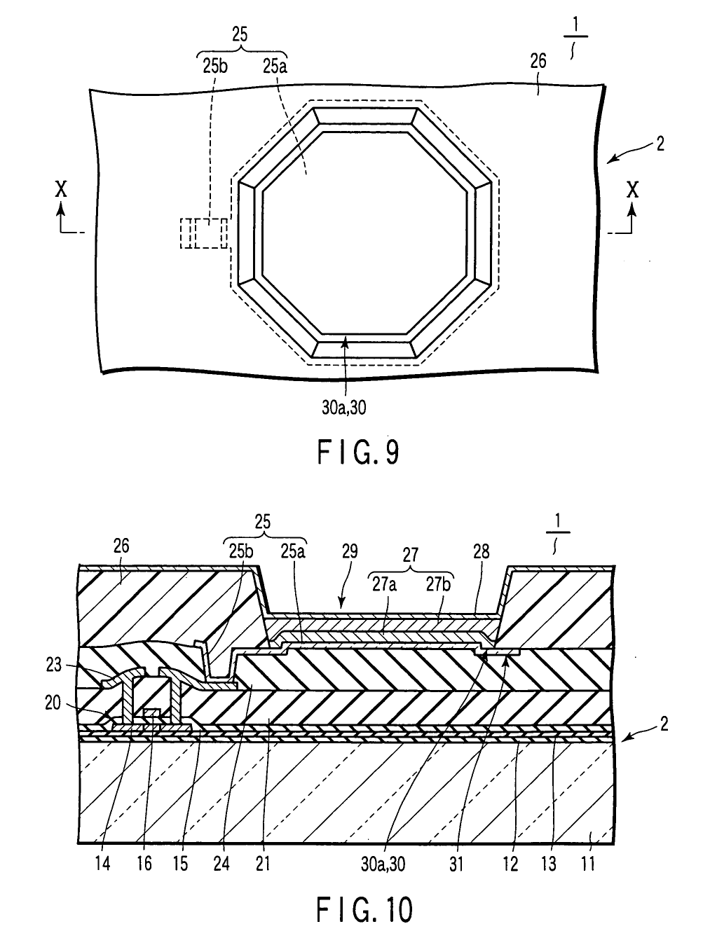

FIG. 9 is a plan view schematically showing the organic EL display according to the third embodiment of the present invention. FIG. 10 is a sectional view taken along a line X-X of the organic EL display shown in FIG. 9. Note that a second electrode 28 is omitted in FIG. 9.

In the second embodiment, the electrode body 25a is made smaller than the through-hole formed in the insulating separator layer 26. In this way, the open annular trench 30b formed between the electrode body 25a and insulating separator layer 26 is used as a part of the trench 30. By contrast, in the third embodiment as shown in FIGS. 9 and 10, an electrode body 25a is made larger than a through-hole formed in an insulating separator layer 26, and a step is formed on the electrode body 25a such that its periphery is lower than its central portion. In this manner, an annular recess 30a serving as a trench 30 is formed between the central portion of the electrode body 25a and the insulating separator layer 26. That is, an uncovered portion of the first electrode 25, which is not covered with the insulating separator layer 26, is composed of a high-level portion, and a low-level portion having an upper surface lower than that of the high-level portion, and the high-level portion is surrounded by the low-level portion.

The third embodiment is the same as the first embodiment except that the structure as described above is used. In this embodiment, the same effects as in the second embodiment can be obtained.

Note that when the structure shown in FIGS. 9 and 10 is used, a projection corresponding to the trench 30 is formed on the surface of the organic layer 27 that faces the substrate 11. That is, in the structure shown in FIGS. 9 and 10, the surface of the organic layer 27 facing the substrate 11 is composed of the first area corresponding to the upper surface of the electrode body 25a, and the second area corresponding to the bottom of the trench 30 and interposed between the first area and the insulating separator layer 26. The distance between the substrate 11 and the second area is shorter than that between the substrate 11 and the first area.

In the second and third embodiments, the width of the trench 30 is desirably, e.g., about 2 to 10 μm. Also, the depth of the trench 30 is desirably equal to or larger than the thickness of the first electrode 25.

As shown in FIGS. 6 and 10, for example, the recess 30a can be formed by providing the surface of the underlayer on which the first electrode 25 is formed, i.e., the surface of the passivation film 24 with a second recess 31.

The second recess 31 can be formed by using etching or the like. For example, the second recess 31 having a desired depth can be formed by half-etching the passivation film 24. Note that half-etching is a technique by which a surface region is removed to such an extent that a layer to be etched is not penetrated, by making the processing time shorter than that of normal etching, or by making the light transmitting density of an exposure mask different from one portion to another.

It is also possible to etch a dielectric interlayer 21 underlying the passivation film 24, instead of etching the passivation film 24. For example, it is possible to form a recess on the surface of the dielectric interlayer 21 by forming a through-hole in the dielectric interlayer 21 by etching, and form the second recess 31 in the surface of the passivation film 24 by using this recess. Alternatively, it is possible to form a recess on the surface of the dielectric interlayer 21 by half-etching, and form the second recess 31 in the surface of the passivation film 24 by using this recess.

The second recess 31 may also be formed by using a film formation method. For example, any layer present between the first electrode 25 and substrate 11 is formed in a plurality of stages. In this method, the second recess 31 can be formed by appropriately setting the numbers of times of film formation in a region corresponding to the first recess 31 and in the other region.

Materials usable as the main constituent elements of the organic EL displays 1 according to the first to third embodiments will be described below.

As the substrate 11, any substrate can be used as long as it can hold a structure formed on it. The substrate 11 is generally a hard substrate such as a glass substrate. However, a flexible substrate such as a plastic sheet may also be used depending on the application of the organic EL display 1.

When the organic EL display 1 is a bottom emission type display which emits light from the side of the substrate 11, a transparent electrode having light transmittance is used as the first electrode 25. As the material of this transparent electrode, a transparent conductive material such as ITO can be used. The film thickness of the transparent electrode is normally about 10 nm to 150 nm. The transparent electrode can be obtained by depositing a transparent conductive material such as ITO by, e.g., evaporation or sputtering, and patterning the obtained thin film by using photolithography.

As the material of the insulating layer 26a, an inorganic insulating material such as a silicon nitride or silicon oxide can be used. The insulating layer 26a made of any of these inorganic insulating materials has relatively high hydrophilic nature.

An example of the material of the insulating layer 26b is an organic insulating material. Organic insulating materials usable as the insulating layer 26b are not particularly limited. When a photosensitive resin is used, the insulating layer 26b having through-holes can be easily formed. Examples of the photosensitive resin usable in the formation of the insulating layer 26b are materials which are formed by adding a photosensitive compound such as naphthoquinonediazide to alkali-soluble polymer derivatives such as phenolic resin, polyacryl, polyamide resin, and polyamic acid, and which give positive patterns upon light exposure and development using an alkali. An example of a photosensitive resin which gives negative patterns is a photosensitive composition which decreases the rate of dissolution into a developer by actinic radiation, e.g., a photosensitive composition having a functional group such as an epoxy group which crosslinks by actinic radiation. The insulating layer 26b is obtained by coating the surface of the substrate 11, on which the first electrode 25 and the like are formed, with any of these photosensitive resins by spin coating or the like, and patterning the obtained coating film by using photolithography.

In the second and third embodiments, an organic insulating material or the like can be used as the material of the insulating separator layer 26. As this organic insulating material, it is possible to use materials similar to those enumerated for the insulating layer 26b.

The film thickness of the insulating separator layer 26 is desirably equal to or larger than the sum of the film thicknesses of the buffer layer 27a and emitting layer 27b, and is normally about 0.09 to 0.13 μm. Also, the film thickness of the insulating layer 26a is normally about 0.05 to 0.1 μm. In the formation of the buffer layer 27a and emitting layer 27b, the surface of the insulating layer 26b is desirably made ink-repellent by a plasma gas such as CF₄/O₂ beforehand, in order to increase the positional accuracy during solution coating by an inkjet deposition method.

As the material of the buffer layer 27a, it is possible to use, e.g., a mixture of a donor polymer organic compound and acceptor polymer organic compound. As the donor polymer organic compound, it is possible to use, e.g., a polythiophene derivative such as polyethylenedioxythiophene (to be referred to as PEDOT hereinafter) and/or a polyaniline derivative such as polyaniline. As the acceptor organic compound, polystyrenesulfonic acid (to be referred to as PSS hereinafter) or the like can be used.

The buffer layer 27a is obtained by filling, by a solution coating method, a liquid reservoir formed by the insulating separator layer 26 with a solution prepared by dissolving a mixture of a donor polymer organic compound and acceptor polymer organic compound in an organic solvent, and removing this solvent from a liquid film in the liquid reservoir by drying the liquid film. Examples of the solution coating method usable in the formation of the buffer layer 27a are dipping, inkjet, and spin coating. Of these methods, an inkjet deposition method is particularly preferable. Also, the liquid film can be dried under heating and/or reduced pressure, or can be naturally dried.

As the material of the emitting layer 27b, a luminescence organic compound generally used in an organic EL display can be used. Examples of an organic compound which emits red luminescence are a polymer compound having an alkyl or alkoxy substituent group in a benzene ring of a polyvinylstyrene derivative, and a polymer compound having a cyano group in a vinylene group of a polyvinylenestyrene derivative. An example of an organic compound which emits green luminescence is a polyvinylenestyrene derivative in which an alkyl, alkoxy, or aryl derivative substituent group is introduced to a benzene ring. An example of an organic compound which emits blue luminescence is a polyfluorene derivative such as a copolymer of dialkylfluorene and anthracene. In the emitting layer 27b, a low-molecular luminescence organic compound or the like can be further added to any of these high-molecular luminescence organic compounds.

As described above, the emitting layer 27b is obtained by filling, by a solution coating method, a liquid reservoir formed by the insulating separator layer 26 with a solution prepared by dissolving a luminescence organic compound in a solvent, and removing this solvent from a liquid film in the liquid reservoir by drying the liquid film. Examples of the solution coating method usable in the formation of the emitting layer 27b are dipping, inkjet, and spin coating. Of these methods, an inkjet deposition method is particularly preferable. Also, the liquid film can be dried under heating and/or reduced pressure, or can be naturally dried.

The film thickness of the emitting layer 27b is set in accordance with the material used. Normally, the film thickness of the emitting layer 27b is 50 nm to 200 nm.

When the second electrode 28 is a cathode, the second electrode 28 can have a single-layer structure or a multilayered structure. If the second electrode 28 as a cathode is given a multilayered structure, this multilayered structure can be, e.g., a two-layered structure obtained by stacking a main conductor layer containing barium or calcium and a protective conductor layer containing silver or aluminum in this order on the emitting layer 27b. The multilayered structure can also be a two-layered structure obtained by stacking a nonconductor layer containing barium fluoride or the like and a conductor layer containing silver or aluminum in this order on the emitting layer 27b. Furthermore, the multilayered structure can be a three-layered structure obtained by stacking a nonconductor layer containing barium fluoride or the like, a main conductor layer containing barium or calcium, and a protective conductor layer containing silver or aluminum in this order on the emitting layer 27b.

In the first to third embodiments, the first electrodes 25 are formed on the passivation film 24. However, the first electrodes 25 may also be formed on the dielectric interlayer 21. That is, the first electrodes 25 and video signal lines can be formed on the same surface.

Also, in the first to third embodiments, the organic EL display 1 is a bottom emission type display. However, the organic EL display 1 may also be a top emission type display. In this case, an organic insulating layer, for example, can be interposed as a flat layer between the first electrodes 25 and passivation film 24. Inorganic insulating layers are normally formed at high temperatures. Therefore, if the insulating separator layer 26 includes an inorganic insulating layer, no organic layer can be formed on the substrate 11 in the preceding film formation. In the second and third embodiments, however, the insulating separator layer 26 can be composed of organic insulating layers alone. Accordingly, an organic layer can be formed below the insulating separator layer 26.

In the second and third embodiments, the formation of pin-holes and the like in the peripheries of the buffer layer 27a and emitting layer 27b can be suppressed although a single-layer structure is used as the insulating separator layer 26. This effect can also be obtained when a multilayered structure is used as the insulating separator layer 26. For example, as in the first embodiment, the insulating separator layer 26 can be given a two-layered structure including an organic insulating layer 26b having lower affinity for ink, and an inorganic insulating layer 26a formed on the organic insulating layer 26b and having higher affinity for ink.

Also, in the second and third embodiments, through-holes are formed in the insulating separator layer 26 in one-to-one correspondence with the organic EL elements 29, i.e., the electrode main bodies 25a. However, the insulating separator layer 26 may also have another structure, provided that the structure can partition the organic layer 27 for each light emission color. For example, when the organic EL elements 29 which emit red, green, or blue light are arranged into stripes in a display region, band-like openings can be formed in the insulating separator layer 26 in one-to-one correspondence with these stripes. That is, it is possible to form band-like openings in the insulating separator layer 26, and form a band-like organic layer 27 in each opening for a plurality of organic EL elements 29 which emit light having the same color.

Furthermore, when sealing is performed using the opposing substrate 3 in the first to third embodiments, it is possible to extend the life of the elements 29 by encapsulating a desiccant in the space between the substrates 2 and 3, or to improve the heat radiation characteristics by filling this space with a resin.

Examples of the present invention will be explained below.

### EXAMPLE 1

In this example, an organic EL display 1 shown in FIG. 1 was manufactured by the following method.

That is, first, in the same manner as in the conventional TFT formation process, film formation and patterning were repetitively performed on the surface of a glass substrate 11 on which undercoating layers 12 and 13 were formed, thereby forming TFTs 20, a dielectric interlayer 21, electrode lines (not shown), source/drain electrodes 23, and a passivation film 24.

On the passivation film 24, a 50-nm thick ITO film was formed by sputtering. Subsequently, this ITO film was patterned by using photolithography to obtain first electrodes 25. Each first electrode 25 was an octagon having a diagonal length of 55 μm. Note that the first electrodes 25 may also be formed by mask sputtering.

On the surface of the substrate 11 on which the first electrodes 25 were formed, a hydrophilic inorganic insulating layer 26a having holes in one-to-one correspondence with light emitting portions of pixels was formed. The thickness of the insulating layer 26a was 0.1 μm. As shown in FIG. 4, each hole in the insulating layer 26a was an octagon having a diagonal length of 50 μm. Subsequently, the surface of the substrate 11 on which the first electrodes 25 were formed was coated with a photosensitive resin, and the obtained coating film underwent pattern exposure and development to form an ink-repellent organic insulating layer 26b having holes in one-to-one correspondence with light emitting portions of pixels. The thickness of the insulating layer 26b was 3 μm, and each hole in the insulating layer 26b was an octagon having a diagonal length of 58 μm as shown in FIG. 4.

A insulating separator layer 26 was obtained by thus stacking the insulating layers 26a and 26b. Note that a surface treatment using CF₄/O₂ plasma gas was performed on the substrate 11 on which the insulating separator layer 26 was formed, thereby fluoriding the surface of the insulating layer 26b.

Then, buffer layer formation ink was discharged by an inkjet deposition method to form liquid films in liquid reservoirs formed by the insulating separator layer 26. These liquid films were heated to a temperature of 120° C. for 3 min to obtain buffer layers 27a.

After that, on the buffer layers 27a corresponding to red, green, and blue pixels, ink liquids for forming red, green, and blue emitting layers were discharged by an inkjet deposition method to form liquid films. These liquid films were then heated to a temperature of 90° C. for 1 hr to obtain emitting layers 27b.

Subsequently, barium was evaporated in a vacuum on the surface of the substrate 11 on which the emitting layers 27b were formed, and aluminum was then evaporated, thereby forming a second electrode 28. In this manner, a TFT array substrate 2 was completed.

After that, a seal layer 4 was formed by coating the periphery of one major surface of a glass substrate 3 with an ultraviolet-curing resin. The glass substrate 3 and array substrate 2 were then adhered in an inert gas such that the surface of the glass substrate 3 on which the seal layer 4 was formed and the surface of the array substrate 2 on which the second electrode 28 was formed faced each other. In addition, the seal layer was cured by ultraviolet radiation, thereby completing the organic EL display 1 shown in FIG. 1.

### COMPARATIVE EXAMPLE 1

An organic EL display was manufactured following the same procedure as explained in Example 1 except that the structure shown in FIG. 2 was used as an array substrate 2. In this example, a first electrode 25 was an octagon having a diagonal length of 58 μm, a hole in a hydrophilic layer 26a was an octagon having a diagonal length of 50 μm, and a hole in an insulating layer 26b was an octagon having a diagonal length of 55 μm.

The buffer layers 27a and emitting layers 27b of the organic EL displays 1 according to Example 1 and Comparative Example 1 were observed with a cross-section SEM.

Consequently, in the organic EL display 1 according to Example 1, the film thicknesses of the buffer layers 27a and emitting layers 27b were substantially uniform in the positions of through-holes formed in the insulating layer 26a. That is, the organic EL display 1 according to Example 1 had a structure capable of suppressing local current concentration at a portion of the emitting layer 27b. In effect, when images were displayed on the organic EL display 1, the luminance was even in each pixel. By contrast, in the organic EL display 1 according to Comparative Example 1, the film thickness nonuniformity of the buffer layers 27a and emitting layers 27b was large in the positions of through-holes formed in the insulating layer 26a, so the luminance was uneven in each pixel.

### EXAMPLE 2

In this example, an organic EL display 1 shown in FIGS. 5 and 6 was manufactured by the following method.

That is, first, in the same manner as in the conventional TFT formation process, film formation and patterning were repetitively performed on the surface of a glass substrate 11 on which an SiNₓ layer 12 and SiO₂ layer 13 were formed as undercoating layers, thereby forming TFTs 20, a dielectric interlayer 21, various lines (not shown), source/drain electrodes 23, and a passivation film 24. A polysilicon layer was used as a semiconductor layer 14 of the TFT 20, a gate insulating film 15 of the TFT 20 was formed by using TEOS, and MoW was used as the material of a gate electrode 16 of the TFT 20. Also, a 660-nm thick PEO layer was formed as the dielectric interlayer 21, and a 450-nm SiN layer was formed as the passivation film 24. Furthermore, a three-layered structure of Mo/Al/Mo was used as the source/drain electrodes 23.

Photolithography and etching were then used to form a 200-nm deep second recess 31 in the passivation film 24. Subsequently, photolithography and etching were used to form contact holes about 10 μm in diameter in the passivation film 24.

On the passivation film 24, a 50-nm thick ITO film was formed by using sputtering. This ITO film was patterned by using photolithography and etching to obtain first electrodes 25 as anodes. An electrode body 25a of each first electrode 25 was a regular octagon of 80 μm sides. Also, in the position of the second recess 31, a first recess 30a having a depth of 200 nm and a width of 10 μm was formed across a band-like terminal 25b extending from the electrode body 25a. Note that the first electrodes 25 may also be formed by mask sputtering.

The surface of the substrate 11 on which the first electrodes 25 were formed was coated with a positive ultraviolet-curing resin, and the obtained coating film underwent pattern exposure and development and was also baked at 220° C. for 30 min, thereby forming an insulating separator layer 26 having through-holes in one-to-one correspondence with light emitting portions of pixels. The thickness of the partition insulating film 26 was 3 μm, and each through-hole in the insulating separator layer 26 was a regular octagon having a side length of 90 μm on the side of the substrate 11. In this way, an open annular trench 30b having a depth of 50 nm and a width of 5 μm was formed between the electrode body 25a and the insulating separator layer 26.

In a reactive ion etching apparatus, a surface treatment using CF₄/O₂ plasma gas was performed on the substrate 11 on which the insulating separator layer 26 was formed, thereby fluoriding the surface of the insulating separator layer 26.

Subsequently, buffer layer formation ink was discharged by an inkjet deposition method using piezoelectric type inkjet nozzles to form liquid films in liquid reservoirs formed by the insulating separator layer 26. As the buffer layer formation ink, a solution containing 1.0 wt % of PEDOT in an organic solvent was used. Also, the supply rate of the ink was 0.05 mL/min. These liquid films were then heated to a temperature of 200° C. for 300 sec to obtain 100-nm thick buffer layers 27a.

After that, on the buffer layers 27a corresponding to red, green, and blue pixels, ink liquids for forming red, green, and blue emitting layers were discharged by an inkjet deposition method to form liquid films. As each emitting layer formation ink, a solution containing 2.0 wt % of a luminescence organic compound in an organic solvent was used. Also, the ink supply rate was 0.05 mL/min. These liquid films where then heated to a temperature of 100° C. for 15 sec to obtain 150-nm thick emitting layers 27b.

In a vacuum of 10⁻⁷ Pa, barium was evaporated by a thickness of 6,000 nm on the surface of the substrate 11 on which the emitting layers 27b were formed. Subsequently, aluminum was evaporated on this barium layer while the vacuum was maintained. In this manner, a second electrode 28 having a two-layered structure was formed as a cathode.

After that, the periphery of one major surface of a glass substrate (not shown) separately prepared as a sealing substrate were coated with an ultraviolet-curing resin to form a seal layer (not shown). This sealing substrate and the substrate 11 were then adhered in an inert gas such that the surface of the sealing substrate on which the seal layer was formed and the surface of the substrate 11 on which the second electrode 28 was formed faced each other. In addition, the seal layer was cured by ultraviolet radiation. In this way, the organic EL display 1 having 480×640×3 (R, G, B) pixels, i.e., a total of 920,000 pixels was completed.

### EXAMPLE 3

In this example, an organic EL display 1 shown in FIGS. 5 and 6 was manufactured following the same procedure as explained in Example 2 except that a second recess 31 was formed by the following method. That is, in this example, the second recess 31 was not formed by etching a passivation film 24. Instead, a 300-nm thick third recess (not shown) was formed in a dielectric interlayer 21 by using photolithography and etching, thereby forming a 200-nm thick second recess 31 in the passivation film 24, and forming a 200-nm deep, 10-μm wide first recess 30a in a band-like terminal 25b.

### EXAMPLE 4

In this example, an organic EL display 1 shown in FIGS. 9 and 10 was manufactured by the following method.

That is, first, film formation up to a passivation film 24 was performed following the same procedure as explained in Example 2.

A 200-nm deep annular second recess 31 was then formed in the passivation film 24 by using photolithography and etching. Subsequently, contact holes about 10 μm in diameter were formed in the passivation film 24 by using photolithography and etching.

On the passivation film 24, a 50-nm thick ITO film was formed by sputtering. This ITO film was then patterned by using photolithography and etching to obtain first electrodes 25 as anodes. An electrode body 25a of each first electrode 25 was a regular octagon of 80 μm sides. Also, a step corresponding to the second recess 31 was formed on the electrode body 25a.

Then, an insulating separator layer 26 was formed by the same method as explained in Example 2. Between the insulating separator layer 26 and a central portion of the electrode body 25a, a 200-nm deep, 10-μm wide annular first recess 30a was formed.

After that, the same steps as explained in Example 2 were sequentially performed. In this manner, an organic EL display 1 having 480×640×3 (R, G, B) pixels, i.e., a total of 920,000 pixels was completed.

### EXAMPLE 5

In this example, an organic EL display 1 shown in FIGS. 9 and 10 was manufactured following the same procedure as explained in Example 4 except that a second recess 31 was formed by the following method. That is, in this example, the second recess 31 was not formed by etching a passivation film 24. Instead, a 300-nm thick third recess (not shown) was formed in a dielectric interlayer 21 by using photolithography and etching, thereby forming a 200-nm thick second recess 31 in the passivation film 24, and forming a 200-nm deep, 10-μm wide first recess 30a between an insulating separator layer 26 and a central portion of an electrode body 25a.

### COMPARATIVE EXAMPLE 2

In this example, an organic EL display 1 shown in FIGS. 7 and 8 was manufactured following the same procedure as explained in Example 4 except that neither a first recess 30a nor a second recess 31 was formed.

The buffer layers 27a and emitting layers 27b of the organic EL displays 1 according to Examples 2 to 5 and Comparative Example 2 were observed with a cross-section SEM.

Consequently, in the organic EL displays 1 according to Examples 2 to 5, the buffer layer 27a and emitting layer 27b had substantially uniform thicknesses in the position of each through-hole formed in the insulating separator layer 26, and had no chipping or the like. That is, the organic EL displays 1 according to Examples 2 to 5 had structures capable of suppressing a short circuit between the first electrode 25 and second electrode 28 and local current concentration to a portion of the emitting layer 27b. In effect, when images were displayed on the organic EL displays 1, the luminance was even in each pixel.

By contrast, in the organic EL display 1 according to Comparative Example 2, the film thickness nonuniformity of the buffer layers 27a and emitting layers 27b was large in the positions of through-holes formed in the insulating separator layer 26, so the luminance was uneven in each pixel.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. An organic EL display comprising:
a substrate;
an insulating underlayer disposed over the substrate;
a first electrode partially covering the insulating underlayer;
a partition insulting layer disposed on the insulating underlayer and partially covering the first electrode;
an organic layer including an emitting layer and disposed on an uncovered portion of the first electrode that is not covered with the insulating separator layer; and
a second electrode disposed on the organic layer,
wherein a surface of the organic layer that faces the substrate comprises a first area and a second area interposed between the first area and a side surface of the insulating separator layer, and a distance between the substrate and the second area is shorter than a distance between the substrate and the first area.

2. A display according to claim 1, wherein the insulating separator layer comprises:
a first insulating layer covering a periphery of the first electrode and a portion of the substrate that is not covered with the first electrode, the first insulating layer being provided with a first through-hole at a position corresponding to a central portion of the first electrode; and
a second insulating layer disposed on the first insulating layer and provided with a second through-hole at a position corresponding to the first electrode, and
wherein a sidewall of the second through-hole surrounds a region sandwiched between the first and second electrodes and having a contour corresponding to a contour of the first electrode.

3. A display according to claim 2, wherein the insulating separator layer forms a trench surrounding the region, an inner sidewall and a bottom of the trench being composed of a surface of the first insulating layer, and an outer sidewall of the trench being composed of a surface of the second insulating layer.

4. A display according to claim 1, wherein the uncovered portion comprises a high-level portion and a low-level portion, the low-level portion being interposed between the high-level portion and a covered portion of the first electrode that is covered with the insulating separator layer, and an upper surface of the low-level portion being lower in height than an upper surface of the high-level portion.

5. A display according to claim 4, wherein the first electrode and the insulating separator layer form a recess and a trench between the high-level portion and insulating separator layer, a bottom of the recess being composed of a surface of the low-level portion, and a bottom of the trench being composed of a surface of the insulating underlayer.

6. A display according to claim 4, wherein the first electrode comprises an electrode body and a terminal, the terminal outwardly extending from a periphery of the electrode body and made of the same material as the electrode body,
wherein the insulating separator layer is provided with through-hole at a position corresponding to the first electrode,
wherein a sidewall of the through-hole surrounds the electrode body, thereby forming, between the first electrode and insulating separator layer, an open annular trench which opens at a position of the terminal, and
wherein the electrode body comprises the high-level portion, and the terminal comprises the low-level portion.

7. A display according to claim 4, wherein the low-level portion surrounds the high-level portion.

8. A display according to claim 4, wherein the insulating underlayer is provided with a recess at a position corresponding to the low-level portion.

9. A display according to claim 1, wherein the first electrode is an anode, the second electrode is a cathode, and the organic layer further includes a buffer layer between the anode and the emitting layer.

10. A display according to claim 1, wherein the insulating separator layer comprises:
an inorganic insulating layer disposed on a portion of the substrate that is not covered with the first electrode, the inorganic insulating layer partially covering the first electrode; and
an organic insulating layer disposed on the inorganic insulating layer.

11. A display according to claim 1, wherein the insulating separator layer is an organic insulating layer.

12. An organic EL display comprising:
a substrate;
an insulating underlayer disposed over the substrate;
a first electrode partially covering the insulating underlayer;
a partition insulting layer disposed on the insulating underlayer and partially covering the first electrode;
an organic layer including an emitting layer and disposed on an uncovered portion of the first electrode that is not covered with the insulating separator layer; and
a second electrode disposed on the organic layer,
wherein the insulating separator layer comprises:
a first insulating layer covering a periphery of the first electrode and a portion of the substrate that is not covered with the first electrode, the first insulating layer being provided with a first through- hole at a position corresponding to a central portion of the first electrode; and
a second insulating layer disposed on the first insulating layer and provided with a second through-hole at a position corresponding to the first electrode, and
wherein a sidewall of the second through-hole surrounds a region sandwiched between the first and second electrodes and having a contour corresponding to a contour of the first electrode.

13. A display according to claim 12, wherein the insulating separator layer forms a trench surrounding the region, an inner sidewall and a bottom of the trench being composed of a surface of the first insulating layer, and an outer sidewall of the trench being composed of a surface of the second insulating layer.

14. A display according to claim 12, wherein the first insulating layer is an inorganic insulating layer, and the second insulating layer is an organic insulating layer.

15. An organic EL display comprising:
a substrate;
an insulating underlayer disposed over the substrate;
a first electrode partially covering the insulating underlayer;
a partition insulting layer disposed on the insulating underlayer and partially covering the first electrode;
an organic layer including an emitting layer and disposed on an uncovered portion of the first electrode that is not covered with the insulating separator layer; and
a second electrode disposed on the organic layer,
wherein the uncovered portion comprises a high-level portion and a low-level portion, the low-level portion being interposed between the high-level portion and a covered portion of the first electrode that is covered with the insulating separator layer, and an upper surface of the low-level portion being lower in height than an upper surface of the high-level portion.

16. A display according to claim 15, wherein the first electrode and the insulating separator layer form a recess and a trench between the high-level portion and insulating separator layer, a bottom of the recess being composed of a surface of the low-level portion, and a bottom of the trench being composed of a surface of the insulating underlayer.

17. A display according to claim 15, wherein the first electrode comprises an electrode body and a terminal, the terminal outwardly extending from a periphery of the electrode body and made of the same material as the electrode body,
wherein the insulating separator layer is provided with through-hole at a position corresponding to the first electrode,
wherein a sidewall of the through-hole surrounds the electrode body, thereby forming, between the first electrode and insulating separator layer, an open annular trench which opens at a position of the terminal, and
wherein the electrode body comprises the high-level portion, and the terminal comprises the low-level portion.

18. A display according to claim 15, wherein the low-level portion surrounds the high-level portion.

19. A display according to claim 15, wherein the insulating underlayer is provided with a recess at a position corresponding to the low-level portion.
